(19) United States
(12) Patent Application Publication
(10) Pub. No.: US 2012/0063059 A1
(43) Pub. Date: Mar. 15, 2012

(54) HYBRID SUPERCAPACITOR AND METHOD OF MANUFACTURING THE SAME

(75) Inventors: Seung Hyun RA, Gyeonggi-do (JP); Young Hak Jeong, Gyeonggi-do (KR)

(73) Assignee: SAMSUNG Electro-Mechanics Co., Ltd.

(21) Appl. No.: 13/227,024

(22) Filed: Sep. 7, 2011

(30) Foreign Application Priority Data
Sep. 9, 2010 (KR) 10-2010-0088451

(51) Int. Cl. H01G 9/155; H01G 13/00; B82Y 30/00; B82Y 99/00

(52) U.S. Cl. 361/502; 29/25.41; 977/742; 977/948

(57) ABSTRACT

Disclosed herein is a hybrid supercapacitor manufactured according to a method of manufacturing a hybrid supercapacitor including: forming a lithium thin film on one surface of a separator; facing the lithium thin film and an active material layer of an anode each other; forming an electrode cell by alternately disposing the anode and the cathode, having the separator therebetween; and pre-doping the anode with lithium ions from the lithium thin film by receiving the electrode cell and an electrode solution in a housing.

### CROSS REFERENCE TO RELATED APPLICATION

This application claims the benefit of Korean Patent Application No. 10-2010-0088451, filed on Sep. 9, 2010, entitled “Hybrid Supercapacitor And Method Of Manufacturing The Same”, which is hereby incorporated by reference in its entirety into this application.

### BACKGROUND OF THE INVENTION

1. Technical Field

The present invention relates to a hybrid supercapacitor and a method of manufacturing the same, and more particularly, to a technology of performing a lithium ion pre-doping process on an anode by disposing a lithium thin film on each of the surfaces of a separator electrically isolating a cathode from an anode.

2. Description of the Related Art

In general, an electro-chemical energy storage device is a core component of complete product equipment that is indispensably used in all of portable information communication equipment and electronic equipment. In addition, the electro-chemical energy storage device will be certainly used as a high-quality energy source in new and renewable energy fields that are applicable to a future electric vehicle, a portable electronic device, and the like.

Among the electro-chemical energy storage devices, an electro-chemical capacitor may be classified into an electrical double layer capacitor using the principle of an electrical double layer and a hybrid supercapacitor using an electro-chemical oxidation-reduction reaction.

The electrical double layer capacitor is commonly used in fields requiring high-output energy characteristics but it has a problem in that it has a small capacity. On the other hand, many researches into the hybrid supercapacitor have been conducted as a new alternative to improve capacity characteristics of the electrical double layer capacitor.

In particular, among the hybrid supercapacitors, a lithium ion capacitor (LIC) may have capacitance three to four times larger than that of the electric double layer capacitor by doping an anode with lithium ions and as a result, has a larger energy density.

In this case, a process of pre-doping an anode with lithium ions may be made by providing a lithium metal layer in each of the uppermost layer and the lowermost layer of an electrode cell and immersing it in an electrolyte solution. In this case, the lithium metal layers are provided at both ends of the electrode cell, such that the lithium ions may be non-uniformly doped over the stacked anode and the lithium metal layer may remain after the pre-doping process is completed, such that lithium metal is precipitated when the lithium ion capacitor is operated, thereby deteriorating the reliability of the lithium ion capacitor.

In addition, it takes about 20 days to uniformly dope the anode provided in the electrode cell with lithium ions, such that it is not suitable for mass production. That is, in the lithium ion capacitor, a pre-doping process is essentially performed on the anode in order to improve capacity characteristics; however, due to the pre-doping process on the anode, the reliability of the lithium ion capacitor is deteriorated or it is difficult to apply to the mass production.

Therefore, a need exists for a new anode pre-doping process capable of uniformly and rapidly doping the anode with lithium ions in order to mass-produce the high-capacity lithium ion capacitor.

### SUMMARY OF THE INVENTION

An object of the present invention is to provide a hybrid supercapacitor performing a lithium ion pre-doping process on an anode by providing a lithium thin film on each one surface of a separator electrically isolating a cathode from an anode and a method of manufacturing the same.

According to an exemplary embodiment of the present invention, there is provided a method of manufacturing a hybrid supercapacitor, including: forming a lithium thin film on one surface of a separator; facing the lithium thin film and anode active material layers to each other; forming an electrode cell by alternately disposing the anode and the cathode, having the separator therebetween; and pre-doping the anode with lithium ions from the lithium thin film by receiving the electrode cell and an electrode solution in a housing.

The separator may be disposed between the anode and the cathode to electrically isolate the anode from the cathode.

The lithium thin film formed on one surface of the separator may be disposed to face the anode active material layers.

The lithium thin film may have a thickness in the range of 1 to 10 μm.

The anode active material layers may be disposed to face each other, having an anode current collector therebetween.

The anode active material layer may contact the lithium thin film.

The anode current collector may be formed in a non-porous sheet shape.

The cathode may include a cathode current collector and cathode active material layers each disposed on both surfaces of the cathode current collector.

The cathode current collector may be formed in a non-porous sheet shape.

At the forming the lithium thin film on one surface of the separator, the lithium thin film is formed by any one of a vacuum deposition method, a chemical vapor deposition method, and a sputtering method.

According to another exemplary embodiment of the present invention, there is provided a hybrid supercapacitor including a cathode and an anode alternately disposed, having a separator therebetween, wherein the cathode includes a non-porous cathode current collector and cathode active material layers each disposed on both surfaces of the cathode current collector, and the anode includes a non-porous anode current collector and anode active material layers each disposed on both surfaces of the anode current collector.

The separator may have a lithium thin film formed on one surface thereof.

The anode active material layer may include at least any one of natural graphite, artificial graphite, graphite carbon fiber, non-graphitizable carbon, and carbon nano tube.

The cathode active material layer may include activated charcoal.

### BRIEF DESCRIPTION OF THE DRAWINGS

FIGS. 1 to 6 are perspective views for explaining a method of manufacturing a hybrid supercapacitor according to a first exemplary embodiment of the present invention, wherein:

FIG. 1 is a view showing a lithium thin film formed on one surface of a separator according to a first exemplary embodiment of the present invention;

FIGS. 2 and 3 are views showing an anode formed on one surface of the separator according to a first exemplary embodiment of the present invention;

FIG. 4 is a view showing a stacked structure for forming an electrode cell according to a first exemplary embodiment of the present invention;

FIG. 5 is a assembling perspective view showing a state in which an electrode cell is mounted in a housing according to a first exemplary embodiment of the present invention; and

FIG. 6 is a cross-sectional view showing a state in which the electrode cell is encapsulated with the electrode cell according to a first exemplary embodiment of the present invention, and

FIG. 7 is a cross-sectional view of a hybrid supercapacitor according to a second exemplary embodiment of the present invention.

### DESCRIPTION OF THE PREFERRED EMBODIMENTS

Hereinafter, a hybrid supercapacitor according to exemplary embodiments of the present invention will be described in detail with reference to the accompanying drawings. The exemplary embodiments of the present invention to be described below are provided by way of example so that the idea of the present invention can be sufficiently transferred to those skilled in the art to which the present invention pertains.

Therefore, the present invention is not be limited to the exemplary embodiments set forth herein but may be modified in many different forms. In the drawings, the size and the thickness of the apparatus may be exaggerated for the convenience. Like reference numerals denote like elements throughout the specification.

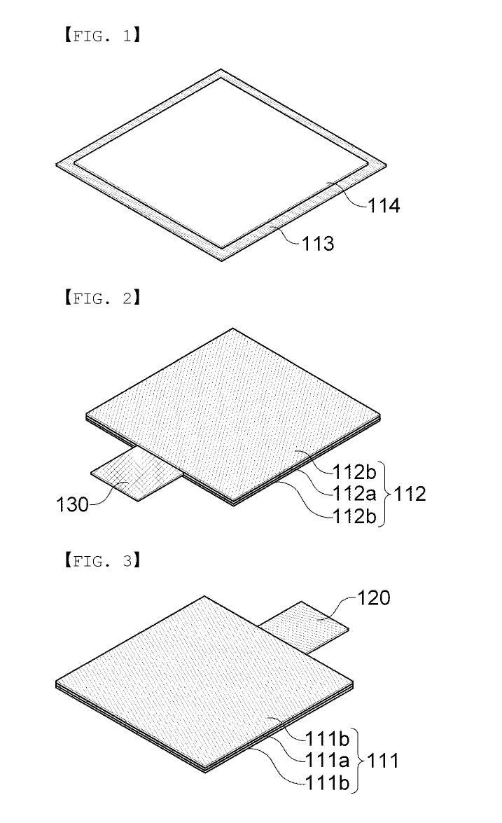

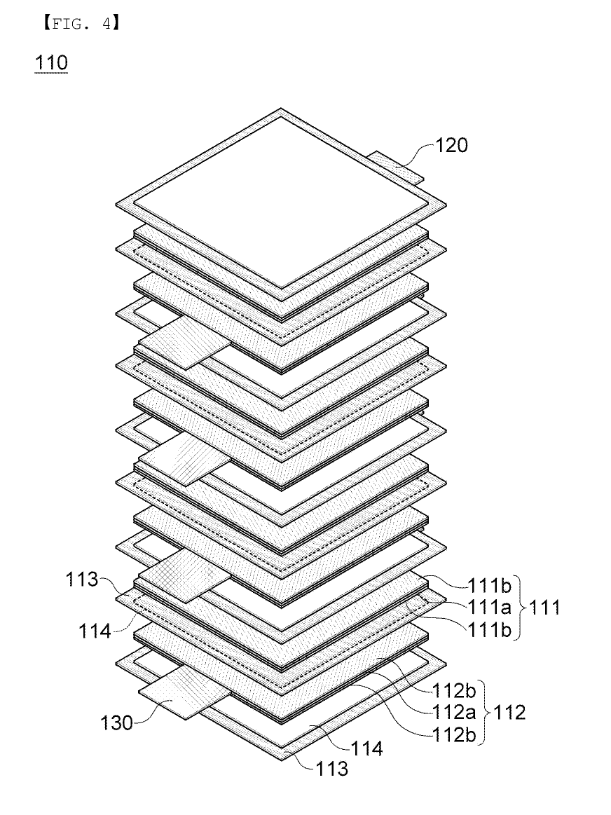

FIGS. 1 to 6 are perspective views for explaining a method of manufacturing a hybrid supercapacitor according to a first exemplary embodiment of the present invention.

Referring to FIG. 1, a lithium thin film 114 is first formed on one surface of a separator 113 in order to manufacture a hybrid supercapacitor 100.

In this configuration, the separator 113 may serve to electrically isolate an anode 112 from a cathode 111, each of which will be described below. An example of forming the separator 113 may include paper, nonwoven, cellulose-based resin, or the like. However, in the exemplary embodiment of the present invention, the kind of the separator 113 is not limited thereto.

A lithium thin film 114 formed on one surface of the separator 13 may serve as a supply source for supplying lithium ions to an anode 112 to be described later. In this case, the lithium thin film 114 may be formed by any one of a vacuum deposition method, a chemical vapor deposition method, and a sputtering method, but in the exemplary embodiment of the present invention, the method of forming the lithium thin film 114 is not limited to thereto. In this case, the lithium thin film 114 may have a thickness in the range of 1 to 10 μm. In this case, when the lithium thin film 114 is less than 1 μm, the amount of lithium to be doped on the anode 112 is too small as well as the contact resistance between an anode active material layer 112b and the lithium thin film 114 is increased, such that the pre-doping process may not be executed well. On the other hand, when the lithium thin film 114 exceeds 10 μm, it may remain on the separator 113 after the pre-doping process is performed on the anode 112. In this case, the thickness of the lithium thin film 114 is not limited thereto and may be changed according to the material or thickness of the anode.

Referring to FIG. 3, the anode 112 is provided on the separator 113, in addition to forming the lithium thin film 114 on the separator 113. The anode 112 may include anode current collectors 112a and anode active material layers 112b disposed on both surfaces of the anode current collectors 112a. The anode current collectors 112a may be made of metal, for example, any of copper, nickel, and stainless. The anode current collectors may be formed in a non-porous shape.

The anode active material layer 112b may be made of a carbon material capable of reversibly doping and undoping lithium ions. For example, the anode active material layer 112b may be made of any one or a mixture of two or more of natural graphite, artificial graphite, mesophase pitch based carbon fiber (MCF), mesocarbon microbead (MCMB), graphite whisker, graphite carbon fiber, non-graphitizable carbon, polyacene-based organic semiconductor, carbon nano tube, composite carbon material of carbon material and graphite material, pyrolysates of furfuryl alcohol resin, pyrolysates of novolac resin, and pyrolysates of condensed polycyclic carbon hydride.

In addition, the anode active material layer 112b may further include a binder. In this case, an example of a material forming the binder may be any one or two or more of fluorine resin such as polytetrafluoroethylene (PTFE), polyvinylidene fluoride (PVdF), or the lie, thermoplastic resin such as polyimide, polyamideimide, polyethylene (PE), and polypropylene (PP), or the like, cellulose resin such as carboxymethyl cellulose (CMC), or the like, rubber resin such as styrene butadiene rubber (SBR), or the like, ethylene propylene diene copolymer (EPDM), polydimethyl siloxane (PDMS), polyvinyl pyrrolidone (PVP), or the like.

Further, the anode active material layer 112b may further include a conductive material such as carbon black and a solvent.

The anode 112 may include anode terminals 130 to connect to the external power supply. The anode terminals 130 may extend from the anode current collectors 112a. In this configuration, since the plurality of anode terminals 130 extend from each anode current collector 112a while being stacked, the stacked anode terminals 130 may be integrated by a supersonic fusing method in order to easily contact the external power supply. In addition, the anode terminals 130 include separate external terminals, such that the anode terminals 130 may be connected to the external terminals by fusing or welding. However, the positions of the anode terminals 130 extending from the current collectors 112a are not limited and may extend in any directions from the anode current collectors 112a according to the request of the user.

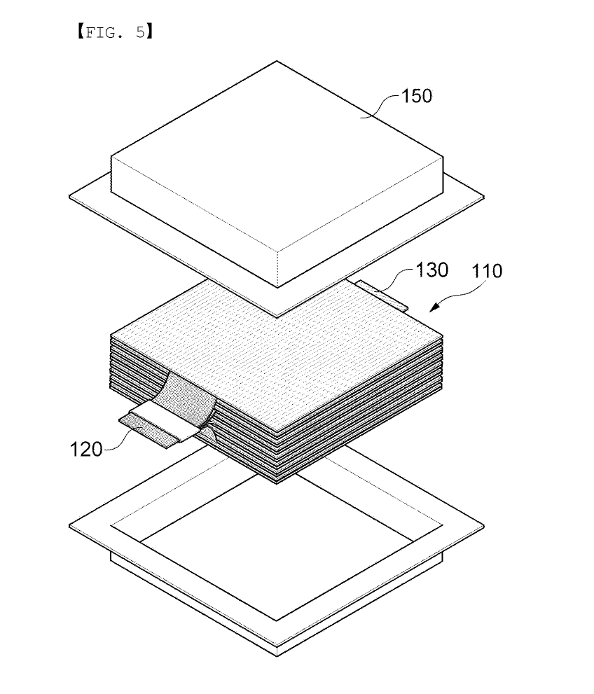

Referring to FIG. 4, the lithium thin film 114 formed in the separator 113 is disposed to face the anode, such that the anode may be doped with the lithium ions of the lithium thin film 112. The lithium ions are not transferred to the cathode 111 to be described later. The cathode 111 is provided, separately from providing the anode.

In this case, the cathode 111 may include a cathode current collector 111a and cathode active material layers 111b each disposed on both surfaces of the cathode current collector 111a.

The cathode current collector 111a may be made of any one of aluminum, stainless, copper, nickel, titanium, tantalum, and niobium. The cathode current collector 111a may have a non-porous sheet shape. As a result, the pre-doping process is performed by directly contacting the lithium thin film to the anode in the subsequent process, such that there is no need for a through hole in the cathode current collector 111a to move the lithium ions. Therefore, the cathode current collector 111a has a non-porous sheet shape, thereby making it possible to reduce the internal resistance of the hybrid supercapacitor.

The cathode active material layer 111b may include a carbon material, i.e., activated charcoal capable of reversibly doping and undoping ions. In addition, the anode active material layer 111b may further include a binder. In this case, an example of a material forming the binder may be any one or two or more of fluorine resin such as polytetrafluoroethylene (PTFE), polyvinylidene fluoride (PVdF), or the like, thermoplastic resin such as polyimide, polyamideimide, polyethylene (PE), and polypropylene (PP), or the like, cellulose resin such as carboxymethyl cellulose (CMC), or the like, rubber resin such as styrene butadiene rubber (SBR), or the like, ethylene propylene diene copolymer (EPDM), polydimethyl siloxane (PDMS), and polyvinyl pyrrolidone (PVP), or the like. In addition, the cathode active material layer 222 may further include a conductive material, for example, carbon black, solvent, or the like.

In this case, the cathode 111 may include cathode terminals 120 to connect to the external power supply. The cathode terminals 120 may be formed by fusing a separate terminal and the positions of the cathode terminals 120 extending from the cathode current collector 111a are not limited and may extend in any directions from the cathode current collector 111a according to the request of the user.

After the separator 113 formed with the lithium thin film 114, the cathode 111, and the anode 112 are provided, the electrode cell 110 is formed by sequentially disposing the cathode 111 and the anode 112, having the separator 113 therebetween. In this configuration, in order to pre-dope the anode 112 with lithium ions, the lithium thin film 114 of the separator 113 contacts the anode active material layer 112b of the anode 112.

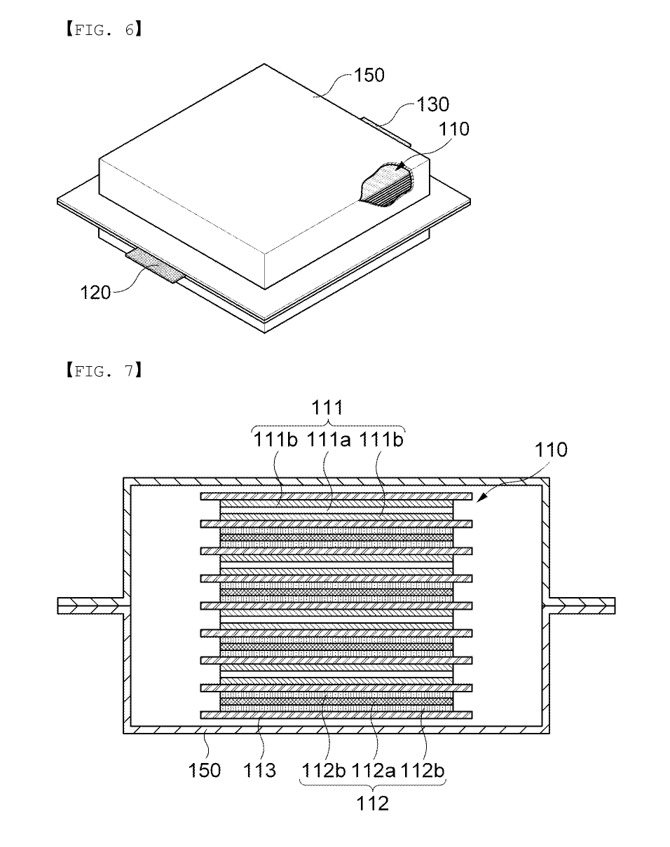

Referring to FIGS. 5 and 6, the exemplary embodiment of the present invention describes that the electrode cell 110 is a pouch type but is not limited thereto. The electrode cell 110 may be a winding type that the cathode 111, the anode 112, and the separator 113 are wound in a roll type. The plurality of stacked anode terminals 130 and the plurality of stacked cathode terminals 120 are each integrated by fusing. In this case, an example of the fusing method may include a supersonic welding, a laser welding, a spot welding, or the like but the exemplary embodiments of the present invention are not limited thereto. In addition, the fused anode terminals 130 and cathode terminals 120 may each be connected to the external terminals.

After the electrode cell 110 is formed, the electrode cell 110 and the electrolyte solution are encapsulated by a housing 150, thereby making it possible to form the hybrid supercapacitor 100.

Specifically describing the encapsulating process of the electrode cell 110, two sheets of laminate films are first provided, having the electrode cell 110 therebetween. Then, the electrode cell 110 may be received in the housing 150 by heat-fusing the two sheets of laminate films. In this case, the fused cathode terminals 120 and anode terminals 130 are exposed from the housing 150 to electrically connect to the external power supply.

In this case, the heat fusing process is performed along edges of the two sheets of laminate films but are performed to keep a gap between the two sheets of laminate films in order to introduce the electrolyte solution into the electrode cell 110 interposed between the two sheets of laminate films. When the electrolyte solution is filled into the housing 150 through the gap, the electrolyte solution may be impregnated into the electrode cell 110, that is, the separator 113, the anode active material layer 112b, and the cathode active material layer 111b.

In addition, when the electrolyte is introduced into the housing 150, the lithium thin film 114 formed in the separator 113 may be pre-doped to the anode due to the difference in potential with the anode 112.

In this case, the electrolyte solution may include an electrolyte and a solvent. The electrolyte may be in a salt sate, for example, a lithium salt state, an ammonium salt state, or the like. The solvent may use aprotic organic solvent. The solvent may be selected in consideration of solubility of an electrolyte, reactivity with an electrode, viscosity, and a use temperature range. An example of the solvent may include propylene carbonate, diethyl carbonate, ethylene carbonate, sulfolane, acetonitrile, dimethoxy ethane, and tetrahydrofuran, and ethyl methyl carbonate, or the like. Herein, the solvent may use one or two or more thereof. For example, the solvent may use a mixture of ethylene carbon and ethyl methyl carbonate. In this case, a mixing ratio of ethylene carbon and ethyl methyl carbonate may be 1:1 to 1:2.

After the filling of the electrolyte solution is completed, the hybrid supercapacitor 100 may be formed by encapsulating the gap in a vacuum state.

In this case, the exemplary embodiment describes that the housing 150 is formed by using the laminate film but is not limited thereto. As a result, the housing 150 may be formed by using a metal can, or the like.

As described in the exemplary embodiment of the present invention, the lithium ions are pre-doped by directly contacting the lithium thin film to the stacked anodes 112 through the separator 113, thereby making it possible to shorten the doping process time. Therefore, the mass production of the hybrid supercapacitor may be increased.

In addition, the pre-doping process of the anode 112 may be performed in the housing 150, such that there is no need for the glove box for the pre-doping process of the anode 112, thereby making it possible to reduction the costs of production facilities. Consequently, the production cost of the lithium ion capacitor can be reduced.

Hereinafter, the lithium ion capacitor manufactured by the method of manufacturing a lithium ion capacitor according to a first exemplary embodiment of the present invention will be described.

FIG. 7 is a cross-sectional view of a lithium ion capacitor according to a second exemplary embodiment of the present invention.

Referring to FIG. 7, a lithium ion capacitor according to a second exemplary embodiment of the present invention may include the electrode cell 110 and the housing (150 of FIG. 6) encapsulating the electrode cell 110 impregnated in the electrolyte solution.

In this configuration, the electrode cell 110 may include the cathode 111 and the anode 112 alternately disposed, having the separator 110 therebetween.

The lithium thin film 114 is formed on one surface of the separator 110 and the lithium thin film is disposed to face the anode active material layer 112b of the anode 112.

The cathode 111 may include the cathode current collector 111a and the cathode active material layers 111b each disposed on both surfaces of the cathode current collector 111a. In this case, since the pre-doping process of the anode 112 is performed by directly contacting the lithium thin film 114 to the anode 112, there is no need to pass the lithium ions through the cathode current collector 111a, such that the cathode current collector 111a may have a non-porous sheet shape. Therefore, the internal resistance of the hybrid supercapacitor 100 may be lowered.

The cathode active material layer 111b may include a carbon material, i.e., activated charcoal capable of reversibly doping and undoping lithium ions.

The cathode 111 may include the cathode terminal 120 disposed at one side of the cathode current collector 111a.

The anode 112 may include an anode current collector 112a and an anode active material layers 112b disposed on both surfaces of the anode current collector 112a.

In this case, an example of the material used for the anode current collector 112a may be a foil made of at least any one of copper and nickel.

The anode active material layer may be made of a carbon material capable of reversibly doping and undoping lithium ions, for example, at least any one of natural graphite, artificial graphite, graphite carbon fiber, non-graphitizable carbon, and carbon nano tube. In this case, the anode active material layer 112b may be pre-doped with lithium ions. The anode 112 may include the anode terminal 130 disposed at one side of the anode current collector 112a.

The hybrid supercapacitor and the method of manufacturing the same according to the exemplary embodiment of the present invention directly performs the pre-doping on the anode by using the lithium thin film formed in the separator, thereby making it possible to shorten the pre-doping process time while uniformly doping the anode with the lithium ions.

In addition, the present invention can uniformly and rapidly dope the anode with the lithium ions, thereby making it possible to manufacturing the high-capacity lithium ion capacitor while securing the reliability and mass production.

Further, the pre-doping process of the electrode can perform the doping due to the difference in potential between the lithium ions and the anode immediately generated when the electrolyte solution is injected into the housing without separately doping the anode with the lithium ions at the outside, such that there is no need for a separate glove box in order to perform the pre-doping process of the electrode, thereby making it possible to reduce the production cost of the lithium ion capacitor.

Moreover, the present invention includes a current collector of which the cathode and the anode have a non-porous shape, thereby making it possible to reduce the internal resistance of the lithium ion capacitor.

What is claimed is:

1. A method of manufacturing a hybrid supercapacitor, comprising:
forming a lithium thin film on one surface of a separator;
facing the lithium thin film and anode active material layers to each other;
forming an electrode cell by alternately disposing the anode and the cathode, having the separator therebetween; and
pre-doping the anode with lithium ions from the lithium thin film by receiving the electrode cell and an electrode solution in a housing.

2. The method of manufacturing a hybrid supercapacitor according to claim 1, wherein the separator is disposed between the anode and the cathode to electrically isolate the anode from the cathode.

3. The method of manufacturing a hybrid supercapacitor according to claim 2, wherein the lithium thin film formed on one surface of the separator is disposed to face the anode active material layers.

4. The method of manufacturing a hybrid supercapacitor according to claim 1, wherein the lithium thin film has a thickness in the range of 1 to 10 μm.

5. The method of manufacturing a hybrid supercapacitor according to claim 1, wherein the anode active material layers are disposed to face each other, having an anode current collector therebetween.

6. The method of manufacturing a hybrid supercapacitor according to claim 5, wherein the anode active material layer contacts the lithium thin film.

7. The method of manufacturing a hybrid supercapacitor according to claim 5, wherein the anode current collector is formed in a non-porous sheet shape.

8. The method of manufacturing a hybrid supercapacitor according to claim 1, wherein the cathode includes a cathode current collector and cathode active material layers each disposed on both surfaces of the cathode current collector.

9. The method of manufacturing a hybrid supercapacitor according to claim 8, wherein the cathode current collector is formed in a non-porous sheet shape.

10. The method of manufacturing a hybrid supercapacitor according to claim 1, wherein at the forming the lithium thin film on one surface of the separator, the lithium thin film is formed by any one of a vacuum deposition method, a chemical vapor deposition method, and a sputtering method.

11. A hybrid supercapacitor including a cathode and an anode alternately disposed, having a separator therebetween, wherein
the cathode includes a non-porous cathode current collector and cathode active material layers each disposed on both surfaces of the cathode current collector, and
the anode includes a non-porous anode current collector and anode active material layers each disposed on both surfaces of the anode current collector.

12. The hybrid supercapacitor according to claim 11, wherein the separator has a lithium thin film formed on one surface thereof.

13. The hybrid supercapacitor according to claim 11, wherein the anode active material layer includes at least any one of natural graphite, artificial graphite, graphite carbon fiber, non-graphitizable carbon, and carbon nano tube.

14. The hybrid supercapacitor according to claim 11, wherein the cathode active material layer includes activated charcoal.
